(19) United States
(12) Patent Application Publication
(10) Pub. No.: US 2014/0006378 A1
(43) Pub. Date: Jan. 2, 2014

(54) SYSTEMS AND METHODS FOR AUDIT PROJECT AUTOMATION

(71) Applicant: FLUOR TECHNOLOGIES CORPORATION, Aliso Viejo, CA (US)

(72) Inventor: Ajay Kandekar, Gurgaon (IN)

(21) Appl. No.: 13/929,119

(22) Filed: Jun. 27, 2013

(30) Foreign Application Priority Data
Jun. 27, 2012 (IN) 1994/DEL/2012

(51) Int. Cl. G06F 17/30

(52) U.S. Cl. CPC G06F 17/30442
USPC 707/713

(57) ABSTRACT

Systems and methods that permit rapid and efficient of auditing of a plant model system utilizing a plant model database are described. Such audits may include testing the performance of system tools, verification that specified tasks have been performed, verification that work package components meet project guidelines, error checking of transferred data, validation of permissions, generation of reports detailing project components or features meeting specified criteria, and/or a combination of these.

This application claims the benefit of priority to Indian Application No. 1994/DEL/2012 filed Jun. 27, 2012 entitled “Systems and Methods for Auditing Project Automation.” This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is auditing systems and methods, specifically as it relates to project automation.

### BACKGROUND

Management of modern construction projects, such as commercial plants, is an enormously complex task. Numerous assemblies, subassemblies, and individual parts may be designed, manufactured, and installed by different organizations nevertheless need to integrated into a functional whole in a timely manner. The advent of computer hardware and software that utilizes database information to provide interactive visual representations of such projects via a plant model can aid in this task to some extent by integrating information from various organization and providing individual users with the ability to easily visualize how their portion of the project “fits” into the overall project plan, check the status of specific components, and make more accurate estimates regarding material and labor costs.

Completion of such complex projects in a coordinated and cost-efficient manner, however, requires careful monitoring and auditing of project activities. Individuals will necessarily track activities related to the portion of the project that falls under their responsibility, a task that can be aided utilizing software that can access database information (as described above). Global auditing of key components of the project as a whole is an enormously complex effort, however, involving analysis of detailed information related to the various work packages that comprise the project in addition to monitoring and verifying the performance of high level, project wide functions. In order to effectively manage such projects these global audits need to be performed frequently, and preferably daily.

Performance of such global audits may be simplified through the use of software that can search for and retrieve information from databases residing in the various commercial entities involved in a construction project. Typical software used for this purpose, such as SmartPlant™ Report (Intergraph™, Huntsville, Ala.) reviews all available databases, runs through a set of queries, and then filters the query results in order to present a user with the desired information. Such a process, however, involves accessing and reviewing a very large and heterogeneous body of information, which in turn leads to audits that require involving significant costs in terms of time and computational resources.

U.S. Pat. No. 6,496,828 to Cochrane et al. discusses an attempt to reduce this burden, using a system that provides a central location for generating and accessing summary tables of information gleaned from databases that reside at remote locations and that may utilize different data structures. These summary tables serve as caches of information that may be relevant to future queries. Following the input of a query by a user the system generates an optimized search strategy in which information is retrieved from these summary tables, which may reduce the time spent retrieving the specified information and the impact on computational resources. Similarly, U.S. Pat. No. 7,080,062 to Leung et al. describes a method for optimizing information search strategies by generating a set of search strategies that utilize both information stored in databases and the stored results from previous, similar queries, and proceeding with the strategy that is least costly. Unfortunately, since both of these approaches rely on the use previously gathered and stored information such methods are not adequate for an audit, which requires current information.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

U.S. pat. publ. no. 2010/00125565 to Burger et al. (publ. May 2010) describes an alternative approach to reduce the cost of large and complex searches by taking into account the burden on computational resources from other tasks, and selecting search strategies that may be less efficient but utilize freely available computational resources to reduce the overall time required to complete the task. U.S. pat. publ. no. 2006/0161515 to Barsness et al. July 2006) addresses the problem of reducing search time in a different fashion, by utilizing an algorithm to reformulate a query entered by the user to shift a specific computation-intensive function of the search (i.e. identification of duplicated results) to later stages in the search process where the data sets may be smaller. It is not clear, however, how these approaches may be applied to multiple databases that may utilize different database structures or to sufficiently reduce the time required to perform searches for audit use of the very large databases utilized by complex projects.

Thus, there is still a need for a rapid and convenient method that supports frequent auditing of large databases, such as those associated with a plant model system to meet the needs of the construction and other industries.

### SUMMARY OF THE INVENTION

The inventive subject matter provides apparatus, systems and methods by which one can quickly and efficiently audit a construction project by utilizing a plant model database within a plant model system, thereby permitting frequent global auditing of a construction project. Such an audit may include, for example, testing the performance of system and/or database tools, verifying that specified tasks have been performed, verifying that work package components meet project guidelines, error checking of transferred data, validating user groups, generating reports detailing project components or features meeting specified criteria, and any combinations thereof.

One embodiment of the inventive concept is a method of auditing a plant model system, where a non-optimized query of a plant model database is used to interrogate a plant model database to provide a result set via an exception generator. In such embodiments, a user interface may be configured to allow a user to select a subset of these results, thereby generating a selected subset and a non-selected subset of results. The selected subset may then be utilized by an optimization engine to generate an optimized database query; the result set thus generated may in turn be utilized by a reporting engine to produce an audit report that includes information from the select subset but not the non-selected subset. In some contemplated embodiments, an editor interface is provided that permits a user to optimize the selected subset to create an optimized subset of the result set. The plant model database may include a log of tasks completed by the system, and the exception generator may be used to review the log of tasks to identify one or more completed and/or incomplete tasks, as desired.

In other contemplated embodiments, the plant model database may be reviewed by the exception generator to provide an analysis that identifies plant objects having incorrect parameters. Alternatively, the plant model database may be reviewed using the exception generator to generate a report or list of plant objects that have incorrect permissions, and/or to generate an audit report that includes assigned permissions of each plant object. Such an object may be, for example, a schematic. In some embodiments, user permission groups may be reviewed using the exception generator to generate a report or list of permission group members that have incorrect parameters, or to generate an audit report that includes permissions of each user.

In yet another embodiment, the method may include performance testing of service tools to provide a result set indicative of the performance status of such tools. Exemplary service tools include interference detection and file name generating services. Some contemplated embodiments may include a reporting engine configured to conduct an error check between an original data source and a replicated data source. Such an error check may utilize a checksum algorithm to verify correct replication of data between the original and replicated data sources.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a diagram of one embodiment of a system for conducting audits of a plant model, where a Plant Model System incorporating a Plant Model Database utilizes query results from outlying databases to produce an audit report.

FIG. 2 represents an embodiment of a method for auditing a plant model system, where a subset of results selected by a user from a non-optimized query are used to generate an optimized query, which in turn is utilized to generate an audit report.

FIG. 3 represents another embodiment of a method for auditing a plant model system, where a subset of results selected by a user from a non-optimized query may be subsequently optimized by the user and used to generate an optimized query, which in turn is utilized to generate an audit report.

FIG. 4 shows an example of an audit report.

FIG. 5 shows an example of an audit report related to pipes and piperuns.

FIG. 6 shows an example of an audit report related to drawings.

### DETAILED DESCRIPTION

It should be noted that while the following description is drawn to a computer/server based auditing system, various alternative configurations are also deemed suitable and may employ various computing devices including servers, interfaces, systems, databases, agents, peers, engines, controllers, or other types of computing, devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing a user with a rapid and computational resource-efficient tools for performing project-wide audits of construction projects, incorporating enumeration, characterization, and status of project components in addition to functional testing of database functions that are key to such projects. The techniques and methods disclosed herein may be performed at high frequency (e.g., daily) without taxing the information system, thereby providing convenient and accurate real time status of large, complex construction projects.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides apparatus, systems and methods by which one can quickly and efficiently audit a construction project by utilizing a plant model database within a plant model system, thereby permitting frequent global auditing of a construction project. Plant model systems permit aggregation of and access to vast amounts of information related to plant construction via a unified interface. For example, a plant model system may incorporate a graphical representation of the completed plant that includes detailed representations of each pipe, fitting, pipe path, power cable, data cable, and so forth. As such they are an invaluable tool for plant design and construction.

Such plant model systems can include a plant model database that serves as a repository for information related to the plant. Since various plant components and subassemblies are frequently produced and installed by a wide range of commercial suppliers, contractors, and subcontractors, the plant model database is often in communication with a number of external databases associated with such external organizations. Thus, information related to a plant under construction may be found in the plant model database, in outlying databases held by other commercial entities, or both.

Information is gathered from such databases utilizing queries, which include logic statements that provide instructions for retrieving data meeting specified criteria. For example, a query may be constructed to interrogate a database for part numbers associated with pipes that have specified ranges of diameter and length. The time required to perform such queries is affected by, among other things, the number of databases to be searched, the size of such databases, and the availability of computational resources available to an information system. Although list generation queries such as that noted above may be accomplished relatively rapidly and with minimal impact, monitoring or auditing an entire project can involve a large number of queries of varying degrees of complexity, which may take considerable time to complete.

Such audits may include, for example, testing of other functionalities or tools of the database that are related functions that affect the project as a whole. An audit may be used to identify error conditions, such as identifying project components that do not meet project guidelines and/or files that contain broken or nonfunctional links. In another example, an audit may be used to verify that a function that detects interference between different project components and/or that name generating services is being performed properly. Other audit functions may include verifying that catalog and model databases are replicated between a central project database and outlying databases, and can further include error checking between original and replicated information. Still other audit functions can include identifying project components that are replicated across different fabrication isometrics and/or occur in multiple work packages, which may be useful in purchase planning. Audits may also serve to address security-related issues, for example verifying that user membership in groups with restricted access or permissions is correct and current as individuals move into and out of a project. In the interests of efficient and coordinated completion of a construction project, it is highly advantageous to have project wide audits performed frequently, preferably daily. Unfortunately, such audits can take considerable time and place a significant burden on an organization's information system.

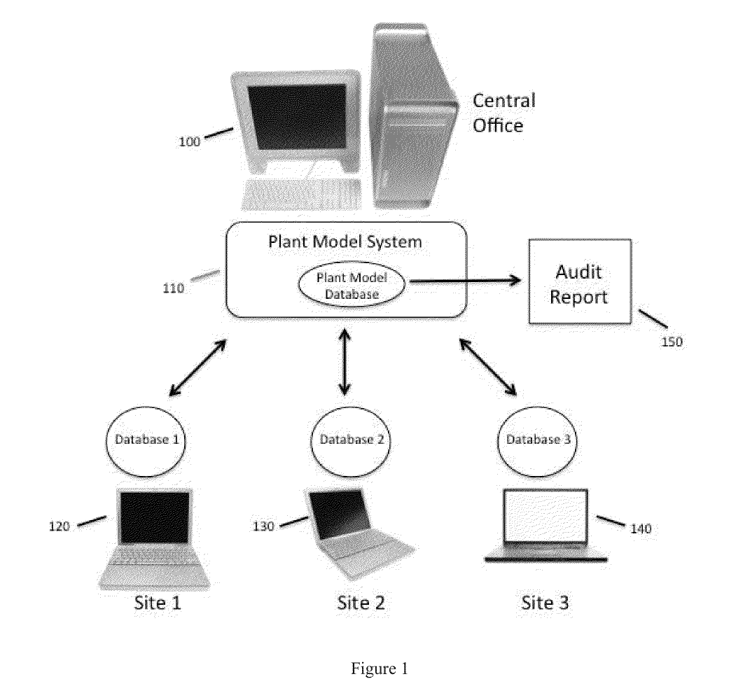

FIG. 1 illustrates an embodiment of a system configured to perform an audit of a plant modeling. A server, personal computer, notebook computer, or any suitable computational device at a central or “home” office 100 includes a Plant Model System 110, which incorporates a Plant Model Database within which information relevant to the plant is stored. The Plant Model Database may be a SQL database or may utilize relational query languages, including but not limited to QL, 4D QL, HTSQL, ISBL, or JPQL. The Plant Model System 110 may be a commercial product, a custom product developed for this purpose, or a combination of these. In a preferred embodiment, the Plant Model System 110 includes a member of the SmartPlant™ suite of products from Intergraph™ (Huntsville, Ala.), such as, for example, SmartPlant 3D™.

The Plant Model System 110 can be in bidirectional communication with one or more offsite information systems, shown as 120, 130, and 140. Such an offsite information system may include, for example, a server, a personal computer, a notebook computer or any suitable computational device. Communication may utilize a wired information network, a wireless information network, or a network that utilizes a combination of wired and wireless mechanisms for transferring data. Offsite data systems can include databases than may be accessed by the Plant Model System 110. In some contemplated embodiments, the offsite information system may differ from the system utilized in the central office 100, and offsite data systems 120, 130, and 140 may differ from each other. Similarly, database software utilized by an offsite data system 120 may differ from that of the Plant Model Database and from database software utilized on other offsite data systems 130 and 140.

As detailed below, on initiation of an audit the Plant Model System 110 may query the databases of one or more offsite information systems (120, 130, 140) to retrieve relevant information to the Plant Model Database. The Plant Model Database may then utilize a report generator (not shown) in order to produce an Audit Report (150). In order to support frequent auditing, the time to complete this operation should be less than about one hour from initialization of the audit. In some embodiments, the time between initialization of the audit and production of the Audit Report 150 is less than about 15 minutes. In other embodiments, the time between initialization of the audit and production of the Audit Report 150 is less than about 5 minutes. It is especially preferred that the time between initialization of the audit and production of the Audit Report 150 is less than about 1 minute.

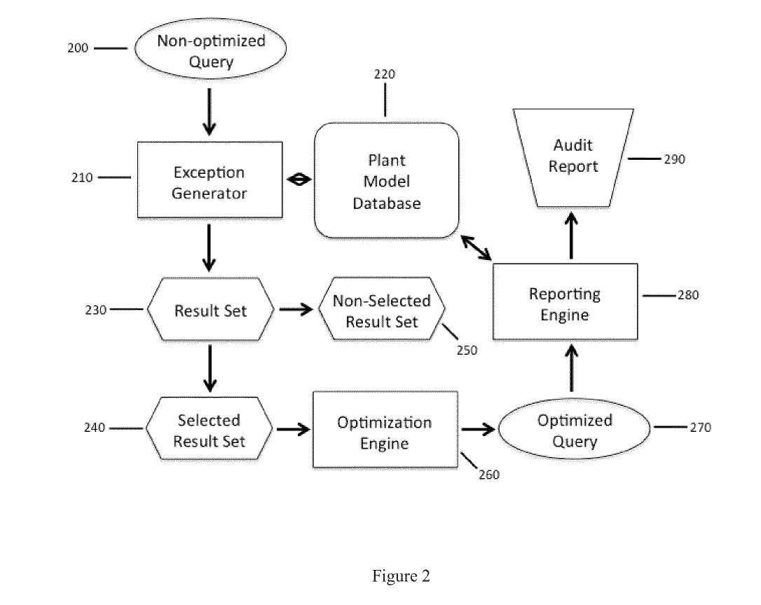

One embodiment of a method for auditing a plant model is shown in FIG. 2. The process begins when a user enters a non-optimized query 200 utilizing a user interface (not shown). Such a query may be entered manually, or alternatively may be entered via selection of a set of query elements presented by the user interface. In some embodiments, the user interface may provide the user with a combined approach for entering queries, displaying a set of selectable query elements and providing fields that the user may manually fill in using a keyboard or similar device. For example, a user may select a project title and a set of project elements from a list displayed by the user interface to initiate an audit. In other contemplated embodiments, queries may be stored by the Plant Model System for later retrieval by a user.

The non-optimized query 200 is utilized by an Exception Generator 210 to interrogate the Plant Model Database 220. This restricts the range of the initial database search to those areas that the user is interested in, advantageously reducing the size of the initial result set when compared to prior art methods. The Plant Model Database 220 may, in turn, request information from external databases as shown in FIG. 1. The Exception Generator 210 generates an initial Result Set 230 utilizing the logic statements of the non-optimized query 200, which is presented to the user via the user interface. In some embodiments, the initial result set 230 may comprise representational data rather than all data present in the Plant Model Database 220 that meet the non-optimized query's 200 criteria. For example, in response to a non-optimized query 200 related to lengths and composition of pipes utilized throughout a specified project, the Exception Generator 210 interrogates the Plant Model Database 220 and displays a result set listing the identifications of a set of pipes, their lengths, and their compositions.

The user can then utilize the user interface to select a selected result set 240 and leaving a non-selected result set 250. An Optimization Engine 260 can be configured to utilize the selected result set 240 to generate an optimized query 270, which is utilized by the Reporting Engine 280 to interrogate the Plant Model Database 220. This advantageously permits a user to generate a sophisticated and selective query utilizing a simple two step process, which can thereby reduce the time required to retrieve the result set and limit the result set to information desired by the user. For example, on reviewing the initial result set 230, the user may choose a selected result set 240 that is restricted to copper pipes above a certain length. The Optimization Engine 260 utilizes this selection to formulate a more complex and refined optimized query 270, which is in turn utilized by the Reporting Engine 280 to interrogate the Plant Model Database 220. The result set derived from the optimized query 270 may form all or part of an Audit Report 290 generated by the Reporting Engine 280.

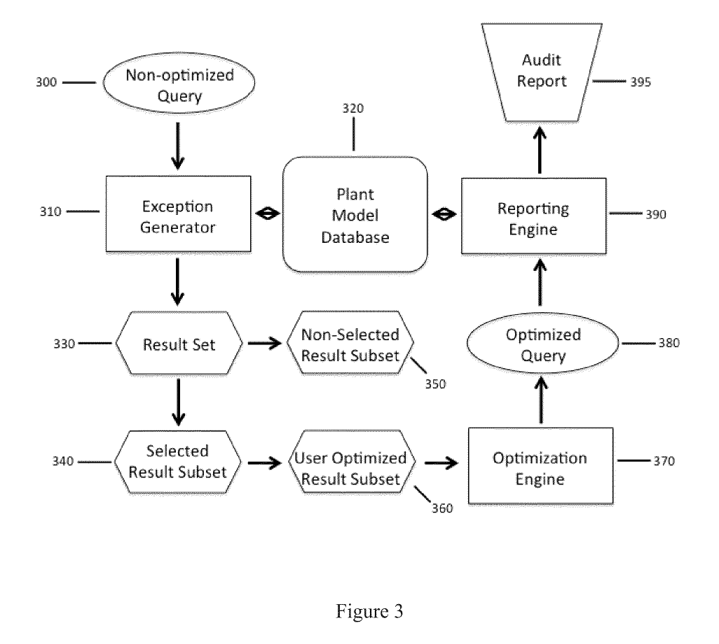

An alternative embodiment of a method for auditing a plant model is shown in FIG. 3. Initial steps of the process are similar to those shown in FIG. 2, with a non-optimized query 300 can be utilized by an Exception Generator 310 to produce an initial result set 330 by interrogating the Plant Model Database 320. The user utilizes a user interface (not shown) to indicate a selected result subset 340, leaving a non-selected result set 350. Following this, the user can utilize an editor interface (not shown) configured to allow the user to further refine the selected result subset 340 to produce a user optimized result subset 360. In some embodiments, the editor interface is configured to display the optimized subset of results. For example, borrowing from the example given above, the user may initially produce a selected result subset 340 that shows information related to pipes used in a specified project that are made of copper and are above a certain length. On further consideration, however, the user may utilize an editor interface to produce a user optimized result subset 360 that further refines the list to restrict it to such pipes that include a 90 degree bend. This advantageously permits a user produce further refinements of their query as needed without the necessity of repeating the process from the beginning.

In other contemplated embodiments, the user may utilize the editor interface to view and select results from the non-selected result subset 350. The user optimized result subset 360 is utilized by the optimization engine 370 to generate an optimized query 380, which is used by the Reporting Engine 390 to gather information from the Plant Model Database 320, which is subsequently used to produce at least part of an Audit Report 395.

The examples given above in relation to FIG. 2 and FIG. 3 describe queries for simple list generation for purposes of illustration, however it is contemplated that the queries can be utilized for a wide variety of functions that may be necessary to perform an effective audit of a Plant Modeling System. For example, a query used to analyze the Plant Modeling System could include verifying or testing the performance of a service tool within the Plant Modeling System. Exemplary tools can include, for example, an interference detection server that provides notification when components of a project interfere with one another and a name generator service. Such verification may include reviewing database contents to determine that information indicating the service has actually been performed has been entered. Alternatively, such verification may include generating a test data entry that should be acted upon by the service tool and reviewing database contents to determine that information indicating that the service has been performed has been entered for this test data.

In still other embodiments, the Plant Model Database can include a log of tasks completed by Plant Modeling System. In such embodiments, a query used in analysis of the Plant Model Database may be utilized by an Exception Generator to identify tasks that have been completed. Alternatively, such a query may be utilized by the Exception Generator to identify tasks that have not been completed. In still another embodiment, a query used in analysis of the plant model database may be utilized by the Exception Generator to identify tasks that have been partially completed.

In other embodiments, a Plant Model Database can be reviewed using an Exception Generator utilizing a query to identify plant objects that have incorrect parameters. Such parameters may be specific to particular plant objects, for instance requiring that a specified grade of material for use in pipes supplying water to clean rooms. Alternatively, such parameters may be related to the project as a whole, for example specifying that the dimensions of pipe runs throughout the project be selected to conform to commercially available pre-cut lengths of pipe and project-wide clearance requirements.

In still other embodiments, security measures can be reviewed, such as verifying permissions related to plant objects. In such embodiments, the Plant Model Database may be queried to review permissions related to plant objects, and the Exception Generator used to generate a list of plant objects that have incorrect permissions. For example, if a plant object (e.g., a part drawing) is accessible by an individual who has transferred to another project, such an object may be listed. It is contemplated that an audit report may be produced having the assigned permissions of each plant object. Alternatively, the Exception Generator may be used to generate a list of individuals having incorrect permissions or for whom permissions have been changed.

Methods of generating an audit report may further include performing an error check between original and replicated database contents. This is particularly advantageous in applications that involve the transfer of large data files between databases or systems including databases, for example in a Plant Model System where large drawing files are routinely transferred between local and offsite computers. The error check may utilize any suitable error detection algorithm, including, for example, checksums, repetition codes, parity bits, cyclic redundancy checks, cryptographic hash functions, and error correcting codes. In a preferred embodiment, a checksum algorithm is used for error detection.

In still other embodiments, the audit report may incorporate results from multiple queries. Such queries may be processed in a serial fashion and the results aggregated by, for example, the Reporting Engine. Alternatively, such queries may be processed in a parallel fashion. Multiple queries may also be assembled into two or more groups, where the queries within a group are processed in parallel and the groups themselves are processed in a serial fashion.

### EXAMPLES

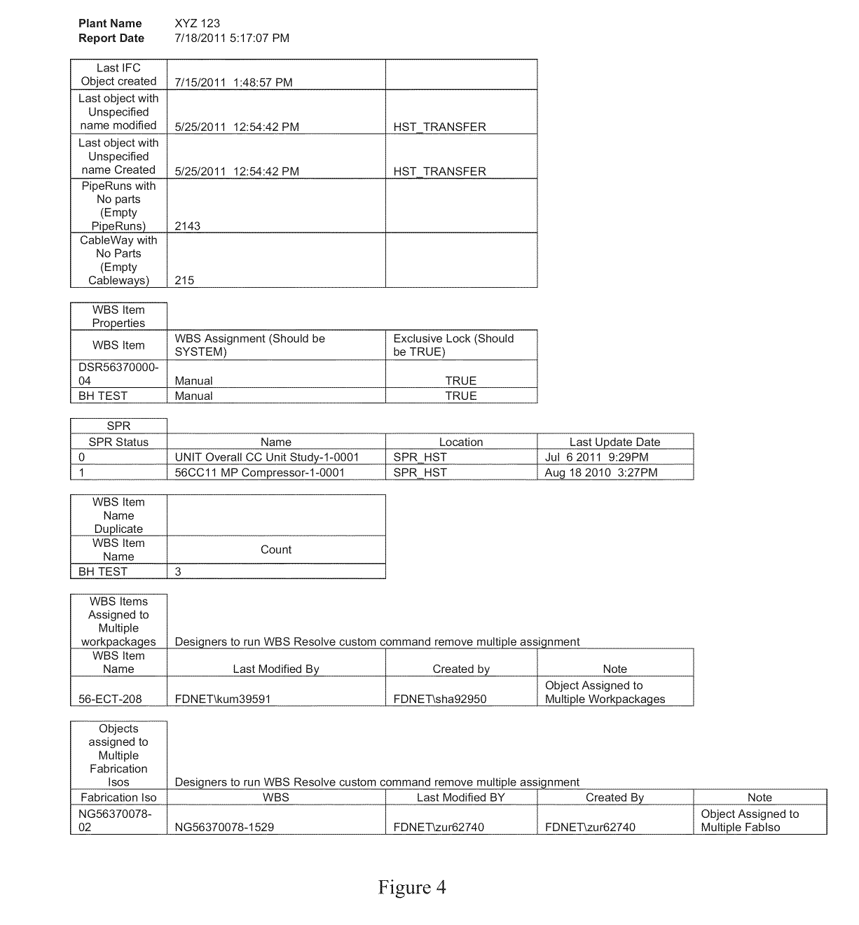

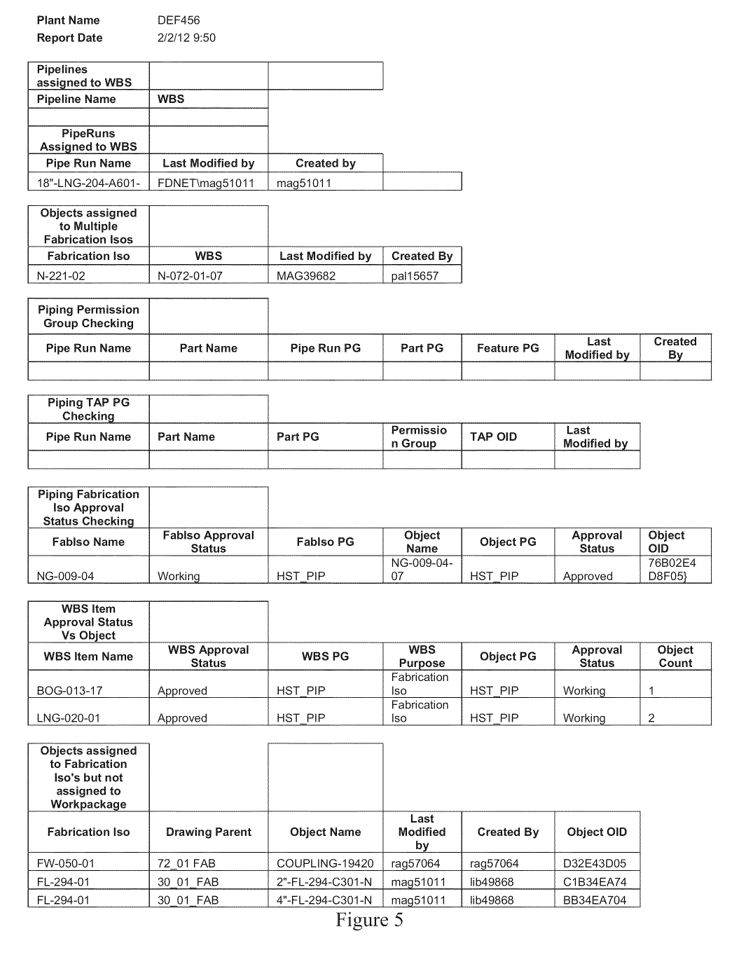

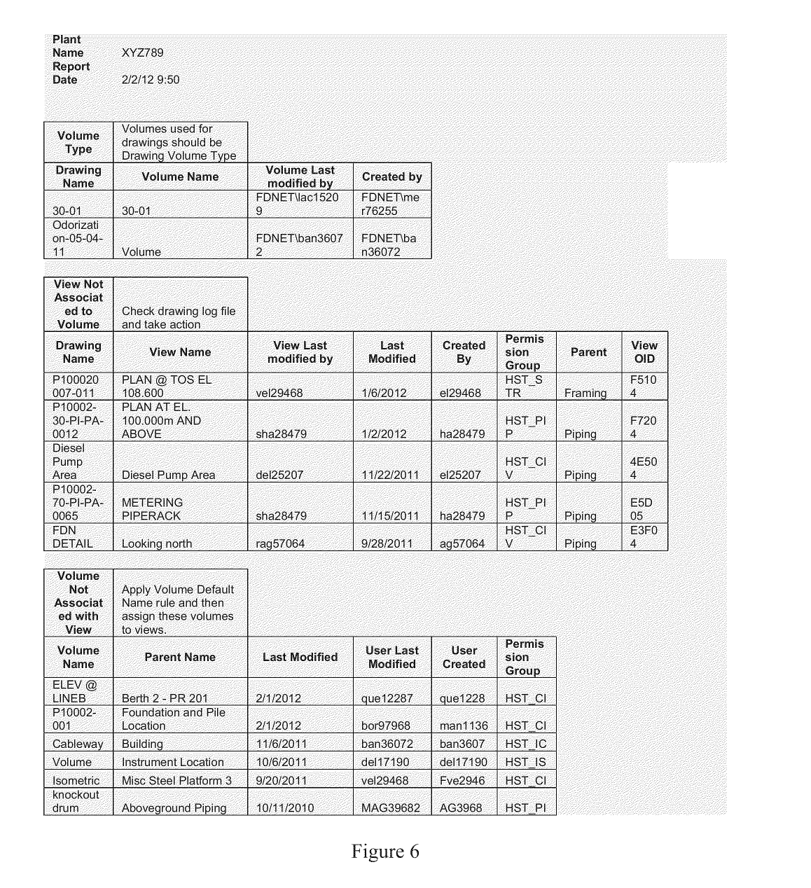

FIG. 4 shows an exemplary report of an audit of a plant modeling system for a construction project, produced by an embodiment of the systems and methods discussed herein. The audit report displays audit information for a specified project, and includes information related to recently produced and edited documents, project features that lack associated parts, item properties, status updates for project components, reports of duplicate item names, a list of items that are utilized in multiple work packages, and a list of items that appear in multiple fabrication isometrics. Such an audit report may include information related to multiple features of the plant modeling system, including, for example, pipes and piperuns, power systems, climate control, transport systems, and so on. Alternatively, an audit report may be include information related to a specific feature of the project. FIG. 5 shows an exemplary report of an audit of a plant modeling system that focuses on pipes and piperuns. In still another embodiment of the inventive concept, the audit report may focus on documentation, including, but not restricted to licenses, certifications, and drawings. FIG. 6 shows an exemplary report of an audit of a plant modeling system that focuses on drawings. Generation of such reports by the method disclosed herein typically required less than one minute, permitting convenient daily auditing of the project. Such an audit report may be conveniently produced in a tabular format that is compatible with commercial spreadsheet and/or word processing programs in order to facilitate incorporation into formal reports. Alternatively, audit data may be displayed in other suitably informative fashions, such as output in the form of graphs, charts or other visual formats.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of auditing a plant modeling system, comprising:
analyzing a plant model database based on a non-optimized query to identify a result set using an exception generator;
configuring a user interface to allow a user to select a subset of the result set to produce a selected subset and a non-selected subset;
generating an optimized query using an optimization engine as a function of the selected subset; and
generating an audit report using a reporting engine based upon the optimized query, wherein the audit report includes the selected subset but not the non-selected subset.

2. The method of claim 1, wherein the step of analyzing the plant model database further comprises testing performance of a service tool within the plant modeling system, and wherein the result set comprises the performance status of the service tool.

3. The method of claim 1, wherein the plant model database further comprises a log of tasks completed by the plant modeling system, and wherein the step of analyzing the plant model database further comprises reviewing the log of tasks using the exception generator to identify whether the tasks were completed.

4. The method of claim 1, wherein the step of analyzing the plant model database further comprises reviewing the plant model database using the exception generator to identify plant objects having incorrect parameters.

5. The method of claim 1, wherein the step of analyzing the plant model database further comprises reviewing permissions of plant objects in the plant model database using the exception generator to identify a list of plant objects having incorrect permissions

6. The method of claim 5, wherein the audit report comprises the assigned permissions of each plant object.

7. The method of claim 1, wherein the step of generating the audit report further comprises the reporting engine conducting an error check against an original data source and a replicated data source.

8. The method of claim 7, wherein the error check comprises a checksum algorithm.

9. The method of claim 1, wherein the step of analyzing the plant model database further comprises reviewing a permission group using the exception generator to identify a member of the permission group having incorrect parameters.

10. The method of claim 1, further comprising providing an editor interface through which the user is permitted to optimize the selected subset to create an optimized subset of the result set.

11. The method of claim 10, further comprising configuring the editor interface to display the optimized subset.

12. A system that audits a plant model, comprising:
a plant model database configured to store a plurality of plant objects;
an exception generator communicatively coupled to the plant model database, wherein the exception generator is configured to (a) analyze the plant model database based on a non-optimized query and (b) generate a result set;
a user interface configured to allow a user to select a subset of the result set to produce a selected subset and a non-selected subset;
an optimization engine configured to generate an optimized query as a function of the selected subset; and
a reporting engine configured to generate an audit report based on the optimized query, where the audit report includes the selected subset but not the non-selected subset.

13. The system of claim 12, wherein the exception generator is further configured to test performance of a service tool and generate a performance status, and wherein the result set comprises the performance status.

14. The system of claim 12, wherein the plant model database is further configured to store a log of tasks completed by a plant modeling software, and wherein the exception generator is further configured to review the log of tasks to identify whether each of the tasks is completed.

15. The system of claim 12, wherein the exception generator is further configured to (a) review plant objects stored in the plant model database, and (b) identify a set of plant objects having incorrect parameters.

16. The system of claim 12, wherein the exception generator is further configured to (a) review plant objects stored in the plant model database, and (b) identify a set of plant objects having incorrect permissions.

17. The system of claim 16, wherein the audit report comprises a list of permissions assigned to each plant object.

18. The system of claim 12, wherein the reporting engine is further configured to compare an original data source and a replicated data source to identify inconsistencies between the data sources, and wherein the audit report comprises a list of the inconsistencies.

19. The system of claim 12, wherein the exception generator is further configured to review a permission group to identify a plant object of the permission group having incorrect parameters.

20. The system of claim 12, further comprising an editor interface configured to allow the user to optimize the selected subset to generate an optimized subset of the result set.
